(19) United States
(12) Patent Application Publication
(10) Pub. No.: US 2025/0155318 A1
(43) Pub. Date: May 15, 2025

(54) HOLDING DEVICE AND METHOD FOR HOLDING AN OPTICAL ELEMENT FOR THE TESTING THEREOF

(71) Applicant: Trioptics GmbH, Wedel (DE)

(72) Inventors: Christian WILDE, Wedel (DE); Kevin BREMER, Wedel (DE); Paul David JORDA, Wedel (DE); Patrik LANGEHANENBERG, Wedel (DE)

(73) Assignee: Trioptics GmbH, Wedel (DE)

(21) Appl. No.: 18/945,205

(22) Filed: Nov. 12, 2024

(30) Foreign Application Priority Data
Nov. 10, 2023 (DE) 10 2023 131 269.3

(51) Int. Cl. G01M 11/02; B25J 15/06

(52) U.S. Cl. CPC G01M 11/0214; B25J 15/0683

(57) ABSTRACT

A holding device for holding an optical element for the testing thereof comprises a hollow base body, a stationary ring and a movable ring. The stationary ring is arranged on or fastened to the base body, wherein the stationary ring has, at one axial end, a contact face for bearing against the optical element. The movable ring is mounted axially displaceably on the base body relative to the stationary ring and the base body, wherein the movable ring has, at one axial end, a contact face for bearing against the optical element. The stationary ring and the movable ring are arranged coaxially with respect to one another, wherein a gap is arranged at least between the stationary ring and the movable ring, in which gap a vacuum for holding the optical element can be generated.

This nonprovisional application claims priority under 35 U.S.C. § 119(a) to German Patent Application No. 10 2023 131 269.3, which was filed in Germany on Nov. 10, 2023, and which is herein incorporated by reference.

### BACKGROUND OF THE INVENTION

### Field of the Invention

The invention relates to a holding device and method for holding an optical element for the testing thereof.

### DESCRIPTION OF THE BACKGROUND ART

A measurement of optical elements or test pieces to be tested in the case of conventional holders with a vacuum can be performed either only on one side or through a glass window. Alternatively, the test piece can conventionally be gripped mechanically on the circumference.

JP2014000621A describes a device for holding a lens with a vacuum without windows in the case of a bonding process. The lens holder comprises an outer region and an inner region which are connected to one another flexibly and imperviously via bearings.

### SUMMARY OF THE INVENTION

It is therefore an object of the invention to provide an improved holding device for holding an optical element for the testing thereof and an improved method for holding an optical element for the testing thereof.

The approach described enables, in particular, secure holding of the optical element to be tested during testing of the same or, in other words, during a measurement and alignment process. For example, the test being influenced by the holding device can also be avoided. Furthermore, in particular, a universally applicable holding device can be provided which can hold optical elements with different geometries.

A holding device for holding an optical element for the testing thereof comprises the following features: a hollow base body; a stationary ring which is arranged on or fastened to the base body, wherein the stationary ring has, at one axial end, a contact face for bearing against the optical element; and a movable ring which is mounted axially displaceably on the base body relative to the stationary ring and the base body, wherein the movable ring has, at one axial end, a contact face for bearing against the optical element, wherein the stationary ring and the movable ring are arranged coaxially with respect to one another, wherein a gap is arranged at least between the stationary ring and the movable ring, in which gap a vacuum for holding the optical element can be generated.

The optical element can be, for example, a lens. The base body can be fastenable or fastened to an actuator. The stationary ring and the base body can be embodied as separate components or as one component. If the stationary ring is arranged on the base body, the stationary ring and the base body can be embodied as a component or as a one-piece component. Moreover, the base body can have a rotationally symmetrical or non-rotationally symmetrical geometry, depending on the type of optical element which is supposed to be held. If the optical element to be held is spherical or aspherical, a cylindrical base body can be used. The stationary ring can be formed to be hollow-cylindrical. The movable ring can be formed to be hollow-cylindrical. In this case, a ring can also be referred to as a ring component, a ring element or a ring unit.

The movable ring can be arranged radially inside or outside the stationary ring. In this manner, both protection for the movable ring and mounting thereof can be reliably realized.

Moreover, a through-opening can be formed in the movable or stationary ring axially through the entire movable ring. The through-opening can also be referred to as an aperture. The holding device can thus be prevented from influencing the testing or measurement since a window can be omitted. This is because measurements through a glass window could be prone to errors since the glass window can have a non-trivially quantifiable and variable influence on measurement results.

In particular, the contact faces of the rings can be formed as cutting edges. Additionally or alternatively, the contact faces can be formed to bear against the optical element along concentric circles. Other concentric geometries, such as e.g. cylinders, would also be conceivable at this point in order to also hold non-rotationally symmetrical test pieces. A holding device in the form of a vacuum double ring cutting edge can thus be provided, which can ensure a secure hold of the optical element, also referred to as the test piece, during a measurement and alignment process. In addition, the vacuum double ring cutting edge can universally fit several test piece geometries in one mounting process.

The holding device can also have a pretensioning apparatus for pretensioning the movable ring away from the base body. In this case, the pretensioning apparatus can have in particular an elastic or compressed air device. The bearing of the movable ring against the optical element can thus be reliably achieved independently of an orientation of the holding device in relation to the gravity field of the Earth.

The base body can have a guide portion which is formed to guide a movement of the movable ring relative to the base body and the stationary ring. In this manner, the movable ring can be guided precisely and reliably in order to enable an adjustment to the geometry of the optical element.

A fit, in particular a clearance fit, is configured as a slide guide between the guide portion of the base body and a guided portion of the movable ring.

Additionally or alternatively, the holding device can have a guide attached to the base body, the guide being formed to guide a movement of the movable ring relative to the base body and the stationary ring. The guide can have in particular a membrane guide. In this manner, exact movement guidance, alongside simultaneous sealing for the vacuum to be applied, can also be achieved.

The base body can furthermore have at least one stop portion which is formed to restrict a movement of the movable ring relative to the base body and the stationary ring. In particular, the movable ring can thus be held securely on the base body without falling out. Moreover, a stroke of the movement can be precisely specified.

A shoulder can also be formed on the movable ring, which shoulder is formed to restrict a movement of the movable ring relative to the base body and the stationary ring. In this manner, the stroke of the movement can be precisely specified. Moreover, reliable holding of the movable ring on the base body can likewise be achieved.

The movable ring can be formed in one part. Such an example offers the advantage that the number of individual parts of the holding device can be kept low. In particular, the movable ring can also be embodied to be particularly robust in this manner.

Also, the movable ring can be formed in multiple parts. In this case, the contact face can be arranged on a first part of the movable ring. A portion guided through the base body can be arranged on a second part of the movable ring. The first part and the second part of the movable ring can be connected to one another. The first part and the second part can be connected to one another in a force-fitting or alternatively form-fitting manner. The first and the second part can be connected to one another directly or via at least one intermediate part.

A method for holding an optical element for the testing thereof can comprise the following steps: arranging an exemplary holding device with the contact faces bearing against the optical element; and generating the vacuum in the gap in order to hold the optical element.

Both the step of arrangement and the step of generation can advantageously be performed in an automated manner. The testing can subsequently be performed on the optical element. In the step of arrangement, the holding device can be moved or the optical element can be moved or both can be moved.

According to an example, in the step of arrangement, the contact face of the movable ring can be pretensioned by means of a pretensioning apparatus bearing against the optical element. In this manner, the bearing of the movable ring against the optical element can be reliably achieved independently of an orientation of the holding device in the space.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic sectional representation of an example of a holding device for holding an optical element for the examination thereof;

FIG. 2 shows a schematic sectional representation of an example of a holding device with a pretensioning apparatus for holding an optical element for the testing thereof; and

FIG. 3 shows a flow chart of an example of a method for holding an optical element for the testing thereof.

### DETAILED DESCRIPTION

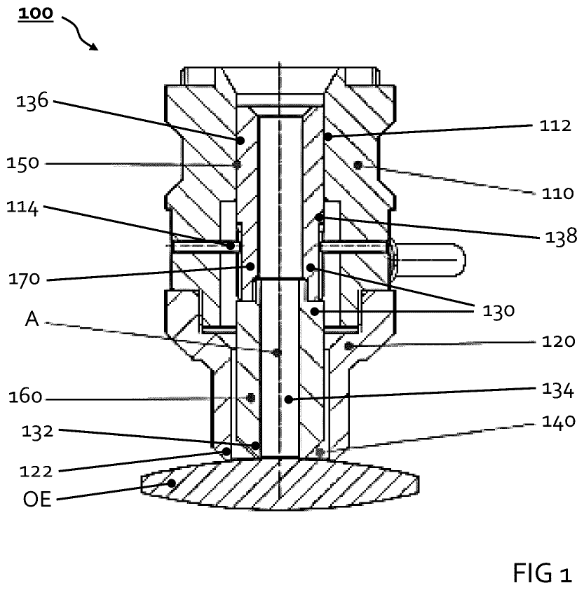

FIG. 1 shows a schematic sectional representation of an example of a holding device 100 for holding an optical element OE for the testing thereof. The holding device 100 is formed to hold an optical element OE, which is, for example, a lens, at least during a testing or a measurement and alignment process of the optical element OE, which can also be referred to as a test piece.

The holding device 100 comprises a base body 110, a fixed or stationary ring 120 and a movable ring 130.

The base body 110 is formed to be hollow, advantageously hollow-cylindrical. The stationary ring 120 is arranged on or fastened to the main body 110. The stationary ring 120 has, at one axial end thereof, a contact face or first contact face 122 for bearing against the optical element OE. The movable ring 130 is mounted axially displaceably on the base body 110 relative to the stationary ring 120 and the base body 110. The movable ring 130 has, at one axial end thereof, a contact face or second contact face 132 for bearing against the optical element OE. The stationary ring 120 and the movable ring 130 are arranged coaxially with respect to one another. Moreover, a gap 140 is arranged at least between the stationary ring 120 and the movable ring 130. A vacuum for holding the optical element OE can be generated in the gap 140. The stationary ring 120 and the movable ring 130 are radially spaced apart from one another by the gap 140.

In particular, the base body 110 acts as a fastening for the fixed or stationary ring 120 or, in other words, as a carrier for the stationary ring 120 and as a guide for the movable ring 130. Moreover, the holding device 100 can be mounted on the base body 110, for example on a test device or in particular on an actuator of a test device.

The movement of the axially displaceable movable ring 130 is performed along an axis A. According to the example represented here, at least the base body 110, the stationary ring 120 and the movable ring 130 are aligned on the axis A, in particular rotationally symmetrically in relation thereto. The axis A represents, for example, an axis of symmetry and/or a main axis of extent of the holding device 100.

The movable ring 130 is arranged radially inside the stationary ring 120. Moreover, a through-opening 134 can be formed in the movable ring 130 axially or along the axis A through the entire movable ring 130. The through-opening 134 can also be referred to as an aperture. In this case, the aperture extends along the axis A through the entire holding device 100. According to an example, the stationary ring 120 can be arranged radially within the movable ring 130. The through-opening 134 can also be formed in the stationary ring 120 axially or along the axis A through the entire stationary ring 120.

Moreover, according to the an example represented here, the contact faces 122 and 132 of the rings 120 and 130 are formed as cutting edges. The holding device 100 can therefore also be referred to as a vacuum double ring cutting edge. In particular, the contact faces 122 and 132 are thus formed to bear against the optical element OE along concentric circles. For non-rotationally symmetrical test pieces, such as e.g. cylinder lenses, the rings 120/130 can have a corresponding non-rotationally symmetrical concentric geometry.

The base body 110 also has a guide face or a guide portion 112. The guide portion 112 is formed to guide a movement of the movable ring 130 relative to the base body 110 and the stationary ring 120. A fit 150, in particular a clearance fit, is configured as a slide guide between the guide portion 112 of the base body 110 and a guided portion 136 of the movable ring 130.

A guide can additionally or alternatively be attached to the base body 110, which guide are formed to guide a movement of the movable ring 130 relative to the base body 110 and the stationary ring 120. Such guide can have in particular a membrane guide or the like.

The base body 110 has at least one stop portion 114. The stop portion 114 is formed to restrict the movement of the movable ring 130 relative to the base body 110 and the stationary ring 120. In other words, the stop portion 114 is formed to axially restrict the movement of the movable ring 130 along the axis A in at least one direction.

A shoulder 138 is formed on the movable ring 130. The shoulder 138 is formed or configured to restrict the movement of the movable ring 130 relative to the base body 110 and the stationary ring 120. In other words, the shoulder 138 is formed to axially restrict the movement of the movable ring 130 along the axis A in at least one direction.

In particular, the stop portion 114 and the shoulder 138 can, according to an example, interact in order to restrict the movement of the movable ring 130 relative to the base body 110 and the stationary ring 120.

The movable ring 130 is formed in one part or one piece. Alternatively, the movable ring 130 is embodied in multiple parts, in particular with a first part 160 and a second part 170. The contact face 132 is arranged on the first part 160 of the movable ring 130 and a guided portion 136 guided by the base body 110 is arranged on the second part 170 of the movable ring. The first part 160 and the second part 170 of the movable ring 130 are connected to one another.

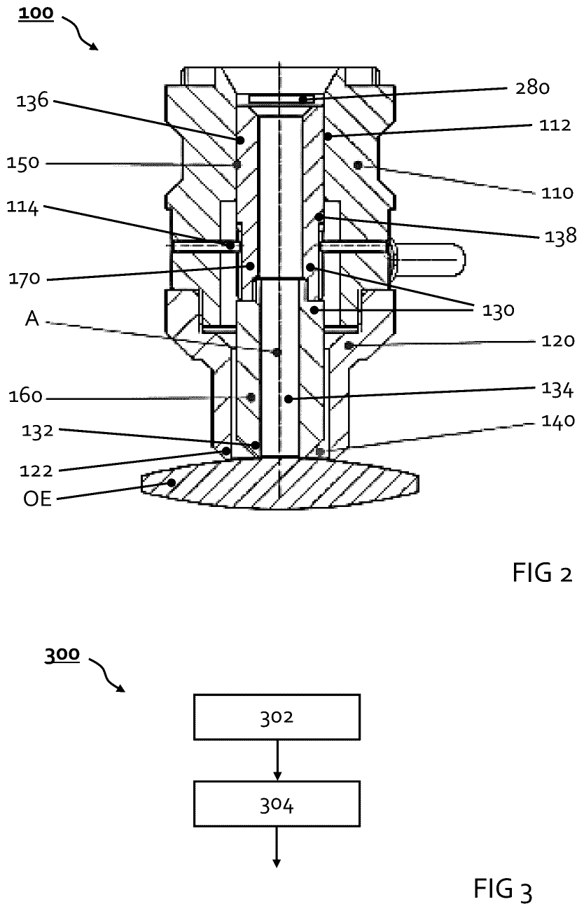

FIG. 2 shows a schematic sectional representation of an example of a holding device 100 with a pretensioning apparatus for holding an optical element for the testing thereof. The holding device 100 corresponds to the holding device from FIG. 1 with the exception of the fact that the holding device 100 also has a pretensioning apparatus 280.

The pretensioning apparatus 280 is formed to pretension the movable ring 130 away from the base body 110. The pretensioning apparatus 280 comprises, for example, an elastic, such as, for example, a spring, or compressed air, in order to move the movable ring 130 away from the base body 110 and/or toward the optical element OE.

The pretensioning apparatus 280 is in this case, by way of example, shown arranged between an end, facing away from the optical element OE, of the movable ring 130, for example of the second part 170 thereof, and an end, facing away from the optical element OE, of the base body 110.

FIG. 3 shows a flow chart of an example of a method 300 for holding an optical element for the testing thereof. The method 300 for holding comprises a step 302 of arrangement and a step 304 of generation. In the step 302 of arrangement, the holding device from one of the figures described above or a similar holding device is arranged with its contact faces bearing against an optical element. Subsequently, in the step 304 of generation, a vacuum is generated in the gap of the holding device in order to hold the optical element.

According to an example, in the step 302 of arrangement, the contact face of the movable ring is pretensioned by means of a pretensioning apparatus bearing against the optical element. Such a pretensioning apparatus is represented, for example, in FIG. 2.

According to an example, it is in particular made possible that the measurement and holding of the test piece or the optical element OE can be performed at the same time and from the same direction without the holder or the holding device 100 influencing the measurement. The holding device 100 is embodied in this case in a manner independent of the test piece and can thus be used universally. The holding device 100 is mountable or mounted on an actuator which can also move the optical element OE, referred to as a test piece.

According to an example, when testing the optical element OE, measurements can thus be prevented from having to be performed through a glass window, which measurements are often prone to errors since the glass window has a non-trivially quantifiable and variable influence. This can also be prevented in particular by means of the through-opening 134. Since it is often not possible to grip the optical element OE at its circumference if there is no space between test piece or optical element OE and frame, an advantageous other holder can be enabled according to an example. In contrast to holding at the circumference, the holder is furthermore universal by means of the holding device 100 since the holding device 100 can adjust to every or almost every test piece geometry.

The holding device 100 embodied as a vacuum double ring cutting edge (VDR) ensures secure holding of the test piece or optical element OE during the measurement and alignment process or during testing. The vacuum double ring cutting edge or holding device 100 has no direct influence on the measurement result. The universal vacuum double ring cutting edge or holding device 100 additionally fits in particular several test piece geometries in a mounting process.

According to an example, a stiff, force-fitting connection between test piece or optical element and periphery can be produced by the holding device 100. The periphery can be an actuator. An influencing of the measurement can be avoided by means of the free aperture or through-opening 134 without windows. This enables use in the case of all devices in the case of which disruptive influences of a window would be critical. The universal embodiment of the holding device 100 saves time and money and thus delivers added value.

According to an example, one of the two rings 120 and 130, i.e. the movable ring 130, is mounted displaceably perpendicular to the holding direction. The fixed or stationary ring 120 defines the position, whereas the movable ring 130 adapts to the test piece or the optical element OE and ensures the vacuum. The contact between the movable ring 130 and the test piece or optical element OE can be ensured by the gravitation or a pretensioning by means of the pretensioning apparatus 280 and can thus be used in any positional orientation. The aperture or through-opening 134 within the inner ring, here the movable ring 130, enables fault-free measurement. The vacuum is built up in the gap 140 between the two rings 120 and 130. The movable ring 130 is on the one hand easily movable in order to adapt to the contour of the optical element OE and can on the other hand ensure the vacuum through a narrow guide and the concentricity of the rings 120 and 130.

The movement of the movable ring 130 can also be realized with a membrane guide instead of by the fit 150 as a slide guide. The pretensioning can be generated by gravitation or other force-storing devices such as springs or compressed air as pretensioning apparatus 280. The movable ring 130 can be embodied in one part or also multiple parts.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A holding device to hold an optical element for the testing thereof, the holding device comprising:
a hollow base body;
a stationary ring arranged on or fastened to the base body, the stationary ring has, at one axial end, a contact face for bearing against the optical element; and
a movable ring mounted axially displaceably on the base body relative to the stationary ring and the base body, the movable ring having, at one axial end, a contact face for bearing against the optical element,
wherein the stationary ring and the movable ring are arranged coaxially with respect to one another, and
wherein a gap is arranged at least between the stationary ring and the movable ring, in which gap a vacuum for holding the optical element is generated.

2. The holding device as claimed in claim 1, wherein the movable ring is arranged radially inside the stationary ring.

3. The holding device as claimed in claim 1, wherein the movable ring is arranged radially outside the stationary ring.

4. The holding device as claimed in claim 1, wherein the base body has a rotationally symmetrical or non-rotationally symmetrical geometry.

5. The holding device as claimed in claim 1, wherein a through-opening is formed in the movable or stationary ring axially through the entire movable or stationary ring.

6. The holding device as claimed in claim 1, wherein the contact faces of the rings are formed as cutting edges, and/or wherein the contact faces are formed to bear against the optical element along concentric, rotationally symmetrical or non-rotationally symmetrical geometries.

7. The holding device as claimed in claim 1, further comprising a pretensioning apparatus for pretensioning the movable ring away from the base body, or wherein the pretensioning apparatus has an elastic or compressed air device.

8. The holding device as claimed in claim 1, wherein the base body has a guide portion which is formed to guide a movement of the movable ring relative to the base body and the stationary ring.

9. The holding device as claimed in claim 8, wherein a fit or a clearance fit is configured as a slide guide between the guide portion of the base body and a guided portion of the movable ring.

10. The holding device as claimed in claim 1, further comprising a guide attached to the base body, the guide formed to guide a movement of the movable ring relative to the base body and the stationary ring, and wherein the guide have a membrane guide.

11. The holding device as claimed in claim 1, wherein the base body has at least one stop portion which is formed to restrict a movement of the movable ring relative to the base body and the stationary ring.

12. The holding device as claimed in claim 1, wherein a shoulder is formed on the movable ring, which shoulder is formed to restrict a movement of the movable ring relative to the base body and the stationary ring.

13. The holding device as claimed in claim 1, wherein the movable ring is formed in one part.

14. The holding device as claimed in claim 1, wherein the movable ring is embodied in multiple parts, wherein the contact face is arranged on a first part of the movable ring, wherein a portion guided through the base body is arranged on a second part of the movable ring, and wherein the first part and the second part of the movable ring are connected to one another.

15. A method for holding an optical element for the testing thereof, the method comprising:
arranging the holding device as claimed in claim 1 with the contact faces bearing against the optical element; and
generating the vacuum in the gap in order to hold the optical element.

16. The method as claimed in claim 15, wherein, in the step of arrangement, the contact face of the movable ring is pretensioned by a pretensioning apparatus bearing against the optical element.
